(19) United States
(12) Patent Application Publication
(10) Pub. No.: US 2007/0196549 A1
(43) Pub. Date: Aug. 23, 2007

(54) Method and Apparatus for Killing Pathogens on Fresh produce

(75) Inventor: Richard S. Brown, Chualar, CA (US)

Correspondence Address: HAYNES BEFFEL & WOLFELD LLP, P O BOX 366, HALF MOON BAY, CA, 94019, US

(73) Assignee: Western Precooling Systems, Fremont, CA (US)

(21) Appl. No.: 11/670,308

(22) Filed: Feb. 1, 2007

Related U.S. Application Data
(60) Provisional application No. 60/774,383, filed on Feb. 17, 2006.

(51) Int. Cl. A23L 3/3409

(52) U.S. Cl. 426/320

(57) ABSTRACT

A method of cooling fresh produce and killing surface pathogens on the fresh produce in a controlled environment. A hydrogen peroxide-containing sanitizing gas is introduced into the controlled environment to contact the fresh produce. The concentration of the sanitizing gas is reduced to a safe level and the produce is then removed. Cooling may be accomplished using a vacuum chamber. The sanitizing gas may be ionized.

### CROSS-REFERENCE TO OTHER APPLICATIONS

This application claims the benefit of U.S. provisional patent application Ser. No. 60/774,383 filed 17 Feb. 2006 and entitled Killing Pathogens and Insects on Fresh Produce, the disclosure of which is incorporated by reference.

### FEDERALLY SPONSORED RESEARCH OR DEVELOPMENT

None.

### BACKGROUND OF THE INVENTION

Food borne illness events are sometimes traced back to contamination on the surface of fresh produce. This invention addresses methods and apparatus for reducing the surface pathogens, such as pathogenic bacteria, viruses and spores, of fresh produce in a safe, efficient manner.

### BRIEF SUMMARY OF THE INVENTION

An example of a method of cooling fresh produce and killing surface pathogens on the fresh produce includes the following steps. Fresh produce is cooled in a controlled environment. A hydrogen peroxide-containing sanitizing gas is introduced into the controlled environment. The sanitizing gas contacts the fresh produce to get cooled, reduced surface pathogen produce. The concentration of the sanitizing gas is reduced to a safe level. The cooled, reduced-pathogen produce is then removed from the controlled environment. In some examples the cooling step comprises placing the produce inside a vacuum chamber and drawing a partial vacuum inside said chamber causing water on, or contained within, the produce to be transformed from a liquid state to a gas state thereby cooling the produce. In other examples the cooling step comprises cooling the controlled environment without any substantial reduction in the pressure within the controlled environment. In some examples ionized hydrogen peroxide-containing sanitizing gas is introduced into the controlled environment.

An example of an apparatus for cooling fresh produce and killing surface pathogens on the fresh produce comprises the following. A controlled environment chamber contains fresh produce, mean-s for cooling the fresh produce within the chamber, and means for introducing a hydrogen peroxide-containing sanitizing gas into the chamber. In some examples the chamber comprises a vacuum chamber and the cooling means comprises means for drawing a partial vacuum within the vacuum chamber. In some examples the introducing means comprises a hydrogen peroxide ionizer whereby the hydrogen peroxide sanitizing gas can be ionized.

Other features, aspects and advantages of the present invention can be seen on review of the figures, the detailed description, and the claims which follow.

### BRIEF DESCRIPTION OF THE DRAWINGS

FIG. 1 is a schematic diagram illustrating one embodiment of a cooling and sanitizing apparatus made according to the present invention carried out using vacuum cooling.

FIGS. 2 and 3 are side and top schematic illustrations of a second embodiment of a cooling and sanitizing apparatus made according to the invention carried out using forced air cooling equipment.

### DETAILED DESCRIPTION OF THE INVENTION

The following description of the invention will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

Some food borne illness events are traced back to contamination on the surface of fresh produce. This invention addresses a method of reducing the surface pathogens, such as pathogenic bacteria, viruses and spores, on fresh produce during the initial cooling step to reduce field heat. The introduction of a sanitizing gas including hydrogen peroxide (H₂O₂) is described using two methods of fresh produce cooling, but this same methodology can be used on other cooling procedures as well. In addition to H₂O₂, sanitizing gases including hydrogen peroxide and one or more other sanitizing agents, such as ozone, acidic acid and chlorine dioxide, may be introduced during the cooling process. However, for simplicity the invention will typically be discussed with reference to H₂O₂ as the sanitizing agent of the sanitizing gas. While in the present invention hydrogen peroxide is typically in the form of vaporized, ionized hydrogen peroxide, it, as well as other sanitizing agents, can be in mist, vapor, atomized or sprayed forms. Also, while ionization of the sanitizing agent, in particular hydrogen peroxide, as a sanitizing gas is typically preferred because it increases the efficiency and speed of the kill of the surface pathogens, that is increases the log reduction of pathogens, in some situations the sanitizing agent may not be in an ionized form.

Vacuum Cooling Embodiment

Vacuum cooling is a method of chilling fresh vegetables such as iceberg lettuce by reducing the pressure inside a rigid chamber. Air is typically drawn from the chamber through a series of refrigeration coils by vacuum pumps. When the pressure inside the chamber lowers to the vapor pressure of water, water is released from the produce thereby releasing energy (latent heat of vaporization). The refrigeration coils collapse the steam back to liquid or frozen water so the vacuum pumps do not have to draw it from the chamber. The process continues until the produce has reached the desired temperature. A typical vacuum cooling cycle for a truckload quantity of iceberg lettuce is 25 minutes to 35 minutes in duration. Vacuum cooling has been practiced for decades and is described in the following exemplary patents: U.S. Pat. No. 4,576,014 to Miller; U.S. Pat. No. 3,008,838 to Brunsing; U.S. Pat. No. 5,922,169 to Later.

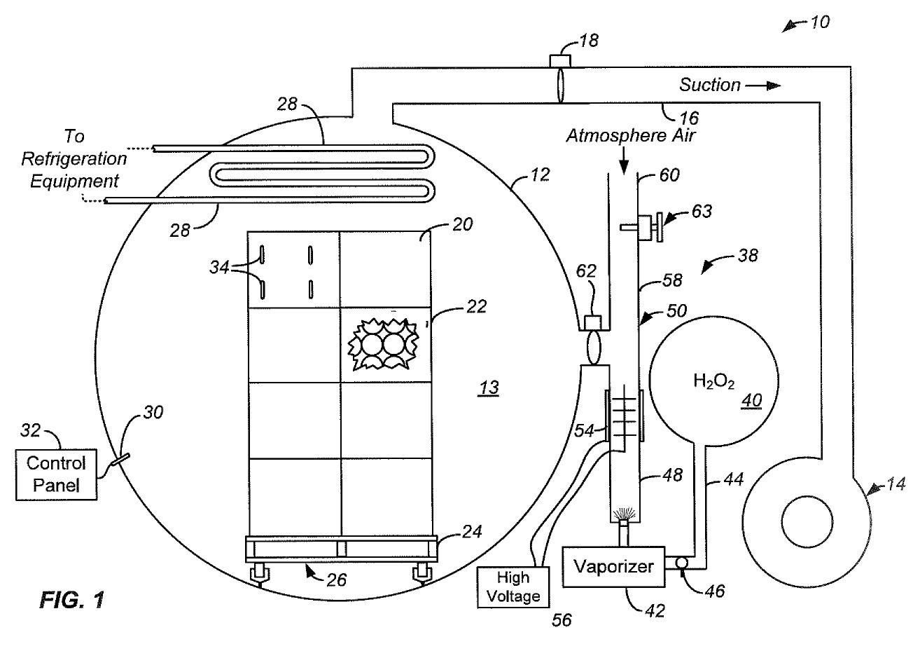

FIG. 1 is a schematic diagram illustrating one embodiment of a cooling and sanitizing apparatus 10 made according to the present invention carried out using vacuum cooling. Apparatus 10 includes a vacuum chamber 12 having an interior 13 coupled to a vacuum pump 14 by a suction pipe 16. Flow through suction pipe 16 is controlled by a suction side valve 18. Cartons 20 of fresh produce 22, such as iceberg lettuce, are loaded on pallets 24 carried by a transport shuttle 26 into and out of vacuum chamber 12. Refrigeration coils 28 are coupled to refrigeration equipment, not shown, and are used to condense water vapor from the air being removed through suction pipe 16. A pressure transducer 30 is connected to a control panel 32 for control of apparatus 10. Holes 34 are provided in the side walls of canons 20 to permit the air within cartons 20 to be exhausted by vacuum from 14 as well as the water vapor created by reducing the pressure within vacuum chamber 12 to a very low pressure, for example 4.6-5.0 mm Hg. The above discussed structure identified by reference numerals 10-34 can be generally conventional.

Apparatus 10 also includes a sanitizing gas assembly 38 designed, in this embodiment, to use hydrogen peroxide as the sanitizing agent. Assembly 38 includes a source 40 of hydrogen peroxide connected to a hydrogen peroxide vaporizer 42 by a pipe 44 with a feed valve 46 along pipe 44. Vaporizer 42 is connected to an ionizing section 48 of a sanitizing gas pipe 50. Ionizing section 48 of pipe 50 includes a dielectric barrier plasma generator 54 connected to a high voltage source 56. Pipe 50 also includes a return air pipe section 58 having an end 60 open to the atmosphere. A restriction valve 63 is placed along return air pipe section 58. Pipe 50 is connected to interior 13 of vacuum chamber 12 through a return air side valve 62.

In use, cartons 20 of fresh produce 22 are placed onto shuttle 26 and transported inside the vacuum chamber 12. The chamber is then closed creating an air tight seal. The return air valve 62 is closed, the suction valve 18 is opened, and vacuum pump 14 is started drawing air through the suction pipe 16 to create a partial vacuum inside the chamber 12. Refrigeration coils 28 are chilled by the refrigeration equipment, not shown, to collapse the steam created during the vacuum cooling cycle. The vacuum cooling process is typically performed in an industry standard method and is controlled through the control panel 32.

At the end of the vacuum cooling cycle, the suction valve 18 is closed. High voltage source 56 energizes the plasma generator 54. Hydrogen peroxide valve 46 is opened to allow hydrogen peroxide from source 40 to flow into the vaporizer 42. Vaporized hydrogen peroxide flows into the ionizing section 48 of sanitizing gas pipe 50. As the vaporized hydrogen peroxide begins to flow, the return air valve 62 is opened drawing the vaporized hydrogen peroxide through the plasma generator 54 and into the interior 13 of the vacuum chamber 12. Vaporized, ionized hydrogen peroxide mixes with air in the return air pipe section 58 and then fills the vacuum chamber 12, passes through the vent holes 34 and coats the surface of the fresh produce 22. Restriction valve 63 is used to adjust the flow of air that passes through the return air pipe section 58 to fine tune the blending of vaporized, ionized hydrogen peroxide with air.

In the preferred embodiment, the vacuum chamber 12 is programmed though the control panel 32 to allow the mixture of air and vaporized, ionized hydrogen peroxide to fill the chamber until the atmosphere inside the chamber reaches a desired set point as indicated by the pressure transducer 30. At that time the hydrogen peroxide feed valve 46 is closed, the return air valve 62 is shut and high voltage electricity from high voltage source 56 to the plasma generator 54 is turned off. A brief delay before proceeding allows the ionized hydrogen peroxide vapors to condense on the cold surfaces of the produce 22. The return air valve 62 is then opened to allow the chamber 12 to return to ambient air pressure. Because the hydrogen peroxide valve 46 remains closed, only air flows through the sanitizing gas pipe 50. The door to vacuum chamber 12 is opened and the shuttle 26 transports pallets 24 of cartons 20 of fresh produce 22 out of the chamber for removal and shipment to market.

In some situations it may be desirable to induce motion to the fresh produce so as to expose more surface area to the sanitizing gas. This can be done in a number of ways, including at least one of the following: vibrating, oscillating, shaking, tumbling, rotating, turning and flipping.

Vacuum Cooling Example

1. Place fresh produce which is not subject to chill injury inside a vacuum chamber.

2. Begin vacuum cooling the product in a conventional fashion.

3. Continue to lower the vacuum to the normal set point as necessary to ensure the product is at the desired temperature (typically about 33° F.). Maintain absolute pressure in the range of 4.6 mm Hg to 5.0 mm Hg for a short period of time as necessary to ensure the field heat has been released.

4. At the end of the cooling cycle, instead of reintroducing air (or nitrogen or a mix of gasses such as air and nitrogen) that occurs during conventional vacuum cooling procedures, the following steps are performed:

a. Direct a stream of vaporized hydrogen peroxide (H₂O₂) through a corona to ionize the stream.

b. Mix this ionized vapor with the air (or a mix of gasses such as air and nitrogen) returning to the vacuum chamber.

c. Continue venting until the absolute pressure has risen to approximately 300 mm Hg.

d. Stop the venting and pause for a period of time to allow the vapors to condense onto the surfaces of the fresh produce. It is also possible to continue applying the ionized vapors until the chamber reaches atmospheric pressure, but some vaporized, ionized H₂O₂ may escape into the air when the chamber is opened causing a potential inhalation risk for workers nearby.

e. Close the H₂O₂ stream and continue venting the chamber to atmospheric pressure (approx 760 mm Hg) with air (or a mix of gasses such as air and nitrogen).

5. Remove the produce from the chamber.

6. Transport to market.

The percent concentration of the H₂O₂ solution (in water) to be vaporized can range from 3% or lower to as high as 70% or more. After the H₂O₂ gives up an Oxygen atom during the disinfection process the remainder is water (H₂O). This makes the choice of H₂O₂ as opposed to some other sanitizing gas or gasses quite desirable. The decision of which concentration is chosen may be determined at least in part by the desired amount of residual surface water on the produce surfaces. For example, iceberg lettuce might be best kept dry while asparagus may perform better with a light surface moisture coating. While this invention allows concentrations of 70% and higher, safety concerns suggest the highest likely solution will be below 50% concentration. H₂O₂ is usually buffered to prevent premature breakdown so it is important to use only buffering agents which are approved for food contact use.

Forced Air Cooling Embodiment

Forced air cooling (also know as pressure cooling) is another method of removing field heat from produce. Forced air cooling is typically used with produce that does not cool acceptably with the vacuum cooling method described above. Typically a plenum containing an electrically driven fan is located along a wall of a cold room. Two rows of produce are placed on either side of the plenum opening. A tarp covers the top gap and end gap between the two rows of produce so that room air is drawn through the produce containers toward the plenum fan. The air which is drawn through the produce is then usually directed toward a set of refrigeration coils. The air is finally returned to the cold room. Cold room air is continually pulled though the produce containers until the produce is cooled to the desired temperature. Typical forced air cooling times are 4 to 6 hours for products such as cantaloupes, depending on initial produce temperature and refrigeration capacity of the cold room.

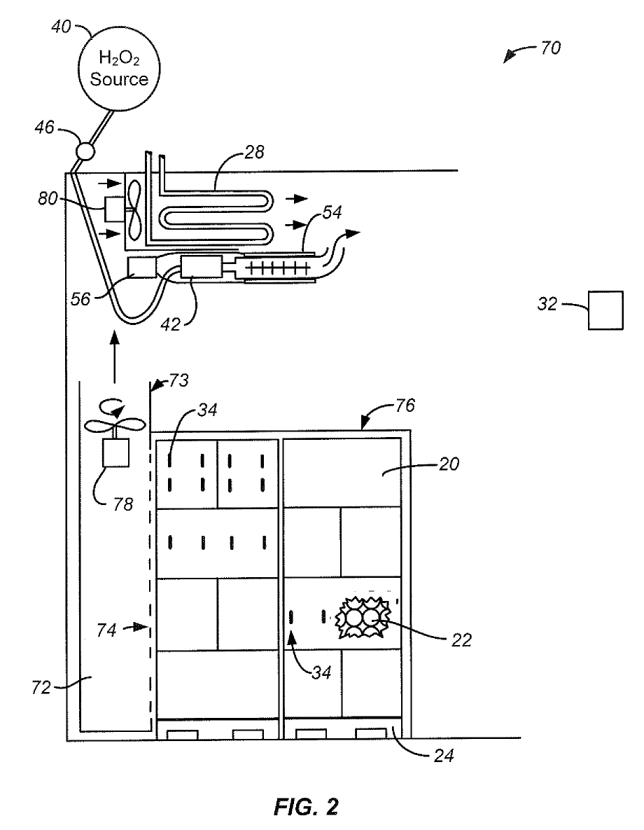

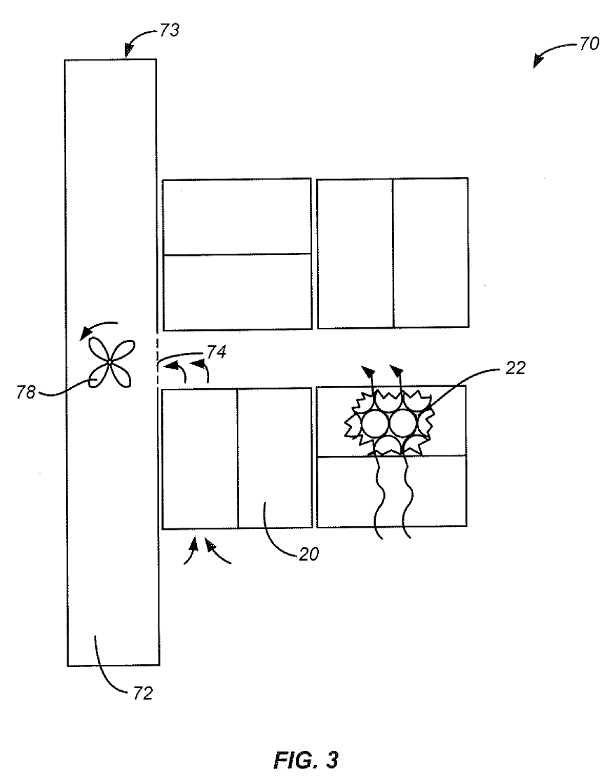

FIGS. 2 and 3 are side and top schematic illustrations of a second embodiment of cooling and sanitizing apparatus 70 made according to the invention. Cartons of fresh produce 20 are generally stacked on a pallet 24. The pallets 24 are then placed in rows against a plenum wall 72 of a plenum 73 on either side of a plenum opening 74 forming two rows of pallets. A tarp 76, shown only in FIG. 2, is laid across the top and front of the pallets to that refrigerated room air which is sucked into the plenum must first travel through the vent holes 34 of the cartons 20 of fresh produce 22.

In use during the cooling cycle of, for example, 4 hours more or less, a plenum fan 78 continues to suck chilled room air through the produce thereby refrigerating it to the desired temperature. Control panel 32 cycles on and off periodically to energize the high voltage source 56 and the hydrogen peroxide vaporizer 42 thereby introducing vaporized, ionized hydrogen peroxide into the air stream blown by a refrigeration coil fan 80.

During the cooling cycle some of the vaporized, ionized hydrogen peroxide condenses on the fresh produce 22 and some continues to pass through plenum 73 and back into the room where it continues to recirculate. Prior to the end of the cooling cycle, control panel 32 turns off the high voltage source 56 and vaporizer 42 so that the remaining vaporized, ionized hydrogen peroxide in the chilled room air can condense safely onto the cold produce 22 or the refrigeration coils 28. Control panel 32 monitors the level of hydrogen peroxide in the room and signals the operator when they are at a low safe level to allow reentry into the room.

Forced Air Cooling Example

1. Produce is placed inside the forced air cooling room. Tarps are arranged in the usual fashion to direct the airflow through the produce containers.

2. Vaporized, ionized H₂O₂ is directed into the flow of air after it passes through the refrigeration coils so that the vapors are spread into the room air.

3. Vapors are injected for a brief periods followed by longer pauses. This process continues until a few minutes before the produce has reached the desired temperature.

4. Continue to cool the produce while allowing the remaining room vapors to condense on cold surfaces of the produce and refrigeration coils.

5. Monitor the air inside the room so that the concentration of vaporized H₂O₂ is at a safe level before reentering the room.

6. Remove the produce and transport to market.

The above descriptions may have used terms such as above, below, top, bottom, over, under, et cetera. These terms are used to aid understanding of the invention and are not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, instead of introducing atmospheric air into vacuum chamber 12, hydrogen peroxide could be mixed with, for example, nitrogen or nitrogen and one or more additional sanitizing agents.

Any and all patents, patent applications and printed publications referred to above are incorporated by reference.

What is claimed is:

1. A method of cooling fresh produce and killing surface pathogens on the fresh produce comprising:
cooling fresh produce in a controlled environment;
introducing a hydrogen peroxide-containing sanitizing gas into the controlled environment;
contacting the fresh produce with the sanitizing gas to get cooled, reduced surface pathogen produce;
reducing the concentration of the sanitizing gas to a safe level; and
removing the cooled, reduced-pathogen produce from the controlled environment.

2. The method according to claim I wherein the cooling step comprises placing said produce inside a vacuum chamber and drawing a partial vacuum inside said chamber causing water on the produce to be transformed from a liquid state to a gas state thereby cooling the produce.

3. The method according to claim 2 wherein the cooling step is carried out resulting in a vapor pressure equivalent to 32° F. to 40° F. water.

4. The method according to claim 2 were in the cooling step is carried out before the introducing step.

5. The method according to claim 4 wherein the cooling step is carried out resulting in a vapor pressure equivalent to 55° F. water or higher so that chill-sensitive produce is undamaged before introducing hydrogen peroxide-containing sanitizing gas into said chamber.

6. The method according to claim 1 wherein the cooling step comprises cooling the controlled environment without any substantial reduction in the pressure within the controlled environment.

7. The method according to claim 6 wherein the introducing step is carried out during the cooling step.

8. The method according to claim 1 wherein the introducing step comprises ionizing the hydrogen peroxide so that ionized hydrogen peroxide-containing sanitizing gas is introduced into the controlled environment.

9. The method according to claim 1 wherein the introducing step comprises introducing a hydrogen peroxide-containing sanitizing gas comprising at least one of ozone, acetic acid, and chlorine.

10. The method according to claim 1 wherein the introducing step comprises introducing hydrogen peroxide in combination with an acid as a sanitizing gas.

11. The method according to claim 10 wherein the introducing step is carried out with acetic acid as the acid.

12. The method according to claim 1 wherein the introducing step comprises introducing a hydrogen peroxide-containing sanitizing gas comprising at least one of:
vaporized hydrogen peroxide;
vaporized and ionized hydrogen peroxide;
atomized hydrogen peroxide;
atomized and ionized hydrogen peroxide;
misted hydrogen peroxide;
misted and ionized hydrogen peroxide;
sprayed hydrogen peroxide; and
sprayed and ionized hydrogen peroxide;

13. The method according to claim I further comprising the step of inducing motion to the fresh produce so as to expose more surface area to the sanitizing gas.

14. The method according to claim 13 wherein the motion inducing step comprises at least one of the following:
vibrating;
oscillating;
shaking;
tumbling;
rotating;
turning; and
flipping.

15. A method according to claim 1 further comprising introducing a second sanitizing gas into the controlled environment.

16. A method according to claim 15 wherein the second introducing step is carried out after the introducing step of claim 1.

17. A method according to claim 15 wherein both the introducing steps are carried out with ionized sanitizing gases.

18. A method according to claim 1 further comprising pre-blending a hydrogen peroxide sanitizing agent and a second sanitizing agent to create a blended hydrogen peroxide-containing sanitizing gas and the introducing step is carried out using the blended hydrogen peroxide-containing sanitizing gas.

19. A method of cooling fresh produce and killing surface pathogens on the fresh produce comprising:
placing fresh produce inside a vacuum chamber and drawing a partial vacuum inside said chamber causing water on the produce to be transformed from a liquid state to a gas state thereby cooling the produce;
introducing an ionized hydrogen peroxide-containing sanitizing gas into the controlled environment;
contacting the fresh produce with the sanitizing gas to get cooled, reduced surface pathogen produce;
reducing the concentration of the sanitizing gas to a safe level; and
removing the cooled, reduced-pathogen produce from the controlled environment.

20. The method according to claim 19 wherein the introducing step comprises introducing ionized hydrogen peroxide in combination with an acid as a sanitizing gas.

21. The method according to claim 19 further comprising the step of inducing motion to the fresh produce so as to expose more surface area to the sanitizing gas.

22. Apparatus for cooling fresh produce and killing surface pathogens on the fresh produce comprising:
a controlled environment chamber containing fresh produce;
means for cooling the fresh produce within the chamber; and
means for introducing a hydrogen peroxide-containing sanitizing gas into the chamber.

23. The apparatus according to claim 22 wherein the chamber comprises a vacuum chamber and the cooling means comprises means for drawing a partial vacuum within the vacuum chamber.

24. The apparatus according to claim 22 wherein the chamber contains air and the cooling means comprises a refrigeration unit, comprising cooling coils, and a fan directing air within the cooling chamber over the cooling coils.

25. The apparatus according to claim 22 wherein the introducing means comprises a hydrogen peroxide ionizer whereby the hydrogen peroxide of the sanitizing gas can be ionized

26. The apparatus according to claim 22 wherein the introducing means comprises at least one of a vaporizer, an atomizer, a mister, and a spray nozzle.

27. The apparatus according to claim 22 further comprising means for introducing at least one additional sanitizing gas into the chamber.

28. The apparatus according to claim 22 further comprising a hydrogen peroxide-measuring sensor within the controlled environment.

28. The apparatus according to claim 28 further comprising a data recorder operably coupled to the hydrogen peroxide-measuring sensor for recording hydrogen peroxide levels within the controlled environment.

29. Apparatus for cooling fresh produce and killing surface pathogens on the fresh produce comprising:
a vacuum chamber containing fresh produce;
means for cooling the fresh produce within the chamber, the cooling means comprising means for drawing a partial vacuum within the vacuum chamber;
means for introducing an ionized hydrogen peroxide-containing sanitizing gas into the chamber;
a hydrogen peroxide-measuring sensor within the vacuum chamber; and
a data recorder operably coupled to the hydrogen peroxide-measuring sensor for recording hydrogen peroxide levels within the controlled environment.
